(19) United States
(12) Patent Application Publication
(10) Pub. No.: US 2009/0221370 A1
(43) Pub. Date: Sep. 3, 2009

(54) FORCE FEEDBACK DEVICE

(75) Inventors: CHIEN-YU CHEN, Tu-Cheng (TW); RONG-HWANG HORNG, Tu-Cheng (TW); YAW-SHEN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/107,002

(22) Filed: Apr. 21, 2008

(30) Foreign Application Priority Data
Feb. 29, 2008 (CN) 200810300445.6

(51) Int. Cl. G06F 17/00

(52) U.S. Cl. 463/36

(57) ABSTRACT

A force feedback device includes a platform, an elastic apparatus, a drive apparatus, a sensor, a control card, and a software system. The software system is configured to process data of a game and transmit data to the control card. The control card is configured to control the drive apparatus to drive the elastic apparatus. The elastic apparatus is configured to control the platform. The sensor is configured to sense the distortion of the elasticity apparatus to know the working status of the platform and transmit data of the distortion to the control card. The control card is configured to process the data of the distortion and transmit it to the software system to change information of the game. The force feedback device has bidirectional data and force transmission.

### BACKGROUND OF THE INVENTION

1. Field of the Invention

The present invention relates to a force feedback device.

2. Description of related art

There are many types of force feedback devices: game pads, joysticks, gloves, steering wheels, trackballs, and mice, etc. One of the famous and popular force feedback devices is game pad of SONY Playstation and NINTENDO 64. When playing some video games, these force feedback devices give users feedbacks as vibrations when users shot the gun or being hit by the enemy.

Wii Fit of NINTENDO uses an unique platform peripheral called the Wii Balance Board that can measure a user's weight and their center of gravity, and calculate their body mass index when told the user's height. The game has about 40 different activities, including yoga poses, push ups, and other exercises. Furthermore, Wii Fit allows its players to compare their fitness by using Wii Fit's own channel on the Wii Menu.

The game pad of SONY Playstation is used to be an output for a game. The Wii Balance Board of NINTENDO is used to be an input for a game. However, the game pad and the Wii Fit only have one-way data or force transmission.

What is needed, therefore, is a force feedback device which has bidirectional data and force transmission.

### SUMMARY

An exemplary force feedback device includes a platform, an elastic apparatus connected to the platform, a drive apparatus, a sensor, a control card, and a software system. A terminal of the drive apparatus is connected to the platform. The other terminal of the drive apparatus is connected to a terminal of the control card. A terminal of the sensor is connected to the elastic apparatus. The other terminal of the sensor is connected to the terminal of the control card. The other terminal of the control card is connected to the software system. The software system is configured to process data of a game and transmit data to the control card. The control card is configured to control the drive apparatus to drive the elastic apparatus. The elastic apparatus is configured to control the platform. The sensor is configured to sense the distortion of the elastic apparatus to know the working status of the platform and transmit data of the distortion to the control card. The control card is configured to process the data of the distortion and transmit data to the software system to change information of the game. The force feedback device has bidirectional data and force transmission.

Other advantages and novel features will become more apparent from the following detailed description when taken in conjunction with the accompanying drawing, in which:

### BRIEF DESCRIPTION OF THE DRAWINGS

FIG. 1 is a block diagram of one embodiment of a force feedback device in accordance with the present invention; and

FIG. 2 is a block diagram of one embodiment of a force feedback device in accordance with the present invention.

### DETAILED DESCRIPTION

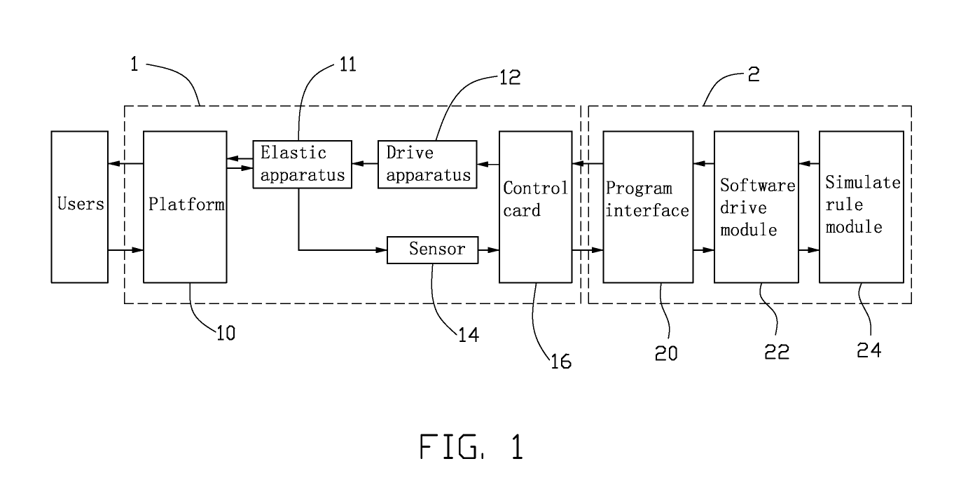

Referring to FIG. 1, a force feedback device acts as an input and an output of a game in accordance with an embodiment of the present invention includes a hardware system 1 and a software system 2. The hardware system 1 includes a platform 10, an elastic apparatus 11, a drive apparatus 12, a sensor 14, and a control card 16. The software system 2 includes a program interface 20, a software drive module 22, and a simulate rule module 24.

The program interface 20 and the software drive module 22 are together configured to set up a simulative parameter. The simulate rule module 24 is configured to process data from the hardware system 1 to change information of the game. The software system 2 is configured to form a game frame, and transmit information of the game frame to the control card 16. The control card 16 is configured to transmit a voltage command according to information of the game frame to the drive apparatus 12. The drive apparatus 12 works according to the voltage command.

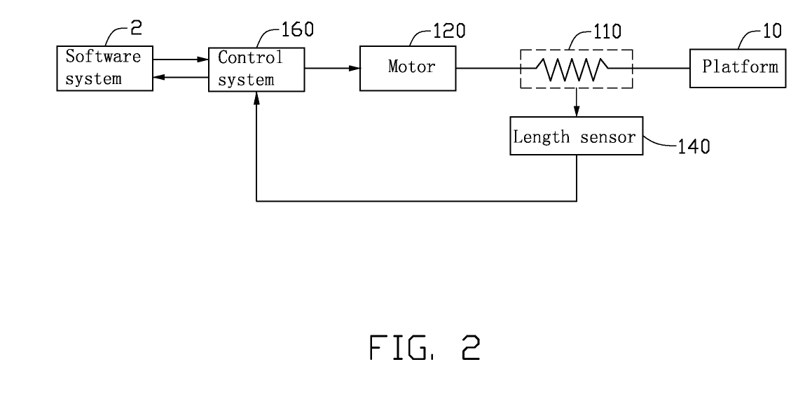

Referring to FIG. 2, the elastic apparatus 11 includes a spring 110. The drive apparatus 12 includes a motor 120. The sensor 14 includes a length sensor 140. The control card 16 includes a control system 160. An input end of the length sensor 140 is connected to the spring 110. An output end of the length sensor 140 is connected to the control system 160. The control system 160 is connected to the software system 2.

The length sensor 140 is configured to sense a distortion of the spring 110, and transmit data of the distortion of the spring 110 to the control system 160. The control system 160 is configured to process the data of the distortion of the spring 110 and transmit the data of the distortion to the software system 2. Furthermore, the control system 160 is configured to receive data from the software system 2 and control the motor 120 correspondingly.

When users play on the platform 10, the length of the spring 100 changes correspondingly. The length sensor 140 senses a distortion and transmits data of the distortion to the control system 160. The control system 160 processes the data of the distortion of the spring 100 and transmits data to the software system 2. The software system 2 processes data from the control system 160 and accepts users' instruction. Here, the force feedback device acts as an input of the game.

When the game generates information correspondingly, the software system 2 processes information from the game and transmits data to the control system 160. The control system 160 controls the motor 120 according to data from the software system 2. The motor 120 drives the platform 10 via the spring 100. Here, the force feedback device acts as an output of the game.

When the force feedback device acts as an input and an output of the game at the same time, the software system 2 works according to information of the game and the distortion of the spring 100. The software system 2 checks users' instruction via the distortion of the spring 100 and changes the game frame correspondingly. Furthermore, the software system 2 controls the motor 120 to drive the spring 100.

For example, when users use the force feedback device to play a simulated skateboard game, the length sensor 140 senses a distortion of the spring 100 is S1 in a positive direction. After the software system 2 processes the data of the distortion of the spring 100, the software system 2 determines user exerts a force of 100 Newton in the positive direction on the back-end of the platform 10. The simulated skateboard in the game will move with a positive acceleration of A1. When the software system 2 determines user exerts a force 100 Newton in the positive direction on the front-end of the platform 10, the simulated skateboard in the game will move with a negative acceleration of A1. If the simulated skateboard is traveling uphill in the game, the software system 2 controls the motor 120 via the control system 160. The motor 120 exerts a force of 100 Newton negative direction on the platform 10. And the data of the distortion of the spring 100 is S1 negative direction. According to the vector rule, users must exert a force of 200 Newton to make the data of the distortion of the spring 100 is positive direction on the back-end of the platform 10. And the skateboard in the game will continue moving with the acceleration of A1.

In this embodiment, numbers of the spring 100 and the motor 120 can change according to need. For example, the platform 10 is a Stewart platform. The Stewart platform has two platforms and six support legs between the two platforms, where the lengths of the legs are changed to position and orient the platform. Each of the six support legs is configured to change location and direction of the two platforms independently. And the Stewart platform has six degree of freedom such as X, Y, Z, pitch, roll, and yaw. Each of the six support legs includes a spring, a motor, and a length sensor. The six motors are connected to the control system 160. The six length sensors are connected to the control system 160.

The spring 100 can be a circularity spring. The platform 10 can be also a revolving platform. The circularity spring is configured to control the revolving platform.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A force feedback device comprising:
a platform;
an elastic apparatus connected to the platform;
a drive apparatus comprising a terminal of the drive apparatus connected to the platform;
a sensor comprising a terminal of the sensor connected to the elastic apparatus;
a control card comprising a terminal of the control card connected to a second terminal of the drive apparatus and a second terminal of the sensor; and
a software system connected to a second terminal of the control card, wherein the software system is configured to process data of a game and transmit data to the control card, the control card is configured to control the drive apparatus to drive the elastic apparatus, the elastic apparatus is configured to control the platform, the sensor is configured to sense the distortion of the elastic apparatus to know the status of the platform and transmit data of the distortion to the control card, the control card is configured to process the data of the distortion and transmit it to the software system to change information of the game.

2. The force feedback device as claimed in claim 1, wherein the sensor comprises a length sensor, one end of the length sensor is connected to the elastic apparatus, the other end of the length sensor is connected to the control card, the length sensor is configured to sense the distortion of the elasticity apparatus and transmit data of the distortion to the control card.

3. The force feedback device as claimed in claim 1, wherein the elastic apparatus is a spring.

4. The force feedback device as claimed in claim 1, wherein the platform is a revolving platform, the spring is a circularity spring, the circularity spring is configured to control the revolving platform.
